(19) United States
(12) Patent Application Publication
(10) Pub. No.: US 2005/0255216 A1
(43) Pub. Date: Nov. 17, 2005

(54) Hydrolysed chitosan as antimicrobial compound and uses thereof

(75) Inventors: Tony Savard, La Presentation (CA); Isabelle Boucher, Montreal (CA); Claude P. Champagne, Sainte-Madeleine (CA)

Correspondence Address: OGILVY RENAULT LLP, 1981 MCGILL COLLEGE AVENUE, SUITE 1600, MONTREAL, QC, H3A2Y3, CA

(73) Assignees: Caldwell Bio Fermentation Canada Inc., Martinville, QC (CA); SA Majeste' La Reine du Chef du Canada, Saint-Hyacinthe, QC (CA); ISM Biopolymer Inc., Granby, QC (CA)

(21) Appl. No.: 10/504,147

(22) PCT Filed: Feb. 20, 2003
(86) PCT No.: PCT/CA03/00241

§ 371 Date: May 6, 2005

Related U.S. Application Data
(60) Provisional application No. 60/357,836, filed on Feb. 21, 2002.

(51) Int. Cl. A23L 1/32

(52) U.S. Cl. 426/614

(57) ABSTRACT

The present invention relates to composition and method for inhibiting growth or propagation of spoilage or pathogen microorganisms in vegetables. Microorganisms, bacteria or yeasts, that can be naturally found or introduced into vegetables before or during their processing, such as fermentation, can be inhibited by treatment with a solution containing hydrolyzed chitosan-lactate. In this way, unprocessed and processed vegetable foods can be preserved for a longer period of time without deterioration.

### TECHNICAL FIELD

This invention relates to antimicrobial compounds and their method of use, particularly in inhibiting growth of propagation of spoilage or pathogen microorganisms in food products.

### BACKGROUND OF THE INVENTION

It is known since a certain period of time that the use of antimicrobial agents to prevent or retard the growth of bacteria finds applicability in a wide variety of applications in food, medical and personal care fields. Some of these applications involve combining an antimicrobial agent with a solid surface. In such cases, it can be necessary to apply an antimicrobial agent to the surface while maintaining the antimicrobial activity of the antimicrobial agent. Unfortunately, in so doing the antimicrobial activity of the antimicrobial agent can be reduced in the process, rendering the resulting material, including food products, insufficiently effective.

In many ways, it would be preferable that the antimicrobial products should not only protect the product until its packaging is first opened by the consumer, but also that the it should prevent or reduce the growth of contaminating microorganisms introduced to the product when used by the consumer. A typical goal is that products with preservative agents should self-sterilize within 24 hours of contamination resulting from normal conditions of use. It is known also that products containing low concentration of alcohol, and having a pH range between about 3 and about 11, are particularly prone to microbial spoilage.

It would be highly desirable to be provided with a new composition that exhibits high antimicrobial activity and being safe for human consumption. Such composition could be useful for different food products.

### SUMMARY OF THE INVENTION

One object of the present invention is to provide a method for inhibiting growth of spoilage or pathogen microorganisms in vegetables comprising treating said vegetables with a composition comprising hydrolysate chitosan-acid complex, said chitosan-acid complex consisting of an oligomer of chitosan complexed to an acid or an acid radical.

The chitosan-acid complex may have a molecular weight between about 0.5 Kda to 1.2 Mda.

The vegetables may be processed vegetables, such as for example fermented or vegetables transformed into paste or liquid solution.

Also, the chitosan-acid complex may be added to the processed vegetables before, during or after processing of it.

The microorganisms that can be inhibited or eliminated with the method of the invention are yeasts, mold, or bacteria, that can be lactic acid bacteria or fermentation yeasts.

The composition of the invention that is also used for the method invention may be a liquid, preferably aqueous, solution.

Another object of the invention is the use of chitosan-acid complex that can be selected from the group consisting of a chitosan-lactate, a chitosan-acetate, a chitosan-chlorate, a chitosan-proprionate, and chitosan complexed to an acid radical having between 3 to 30 carbon atoms.

The microorganisms that can be targeted with the composition and methode of the invention can be selected from the group consisting of, Pichia, Hansenula, Kluyveromyces, Willipsis, and Kluyveromuyces, Leuconostoc, Lactobacillus, Streptococcus, Saccharomyces, Candida, Cryptococcus, Rhodotorula, Shizosaccharomyces, Torulopsis, E. coli, E. coli O157:H7, Salmonella, Staphylococcus, Clostridium, and Bacillus.

Another object of the present invention is to provide a composition for inhibiting growth of spoilage or pathogen microorganisms in vegetables comprising chitosan-acid complex which can be hydrolyzed.

For the purpose of the present invention the following terms are defined below.

As used herein, the term “fermentation” means lactic acid fermentation, that is, the anaerobic, enzymatic decomposition of carbohydrates to form considerable amounts of lactic acid and/or other organic acids. In one embodiment of the present invention, the fermentation microorganism can be bacteria as well as yeast or a mold.

By “growth inhibition” it is meant that the numbers or cell count of the food spoilage organisms or pathogens is decreased or does not increase.

### BRIEF DESCRIPTION OF THE DRAWINGS

FIG. 1 illustrates inhibitory diameters of hydrolysates and native chitosan-lactate at different concentrations on MBA agar for Saccharomyces bayanus Y-43 (A) and Saccharomyces unisporus Y-42 (B);

FIG. 2 illustrates inhibitory diameters of hydrolysates and native chitosan-lactate at different concentrations on MBA agar for Lactobacillus plantarum NK312 (A), Pediococcus acidilactici AFERM 772 (B), and Leuconostoc mesenteroides BLAC (C);

FIG. 3 illustrates growth curves by optical density (600 nm) for Saccharomyces bayanus Y-43 in acidified VJM;

FIG. 4 illustrates growth curves by optical density (600 nm) for Saccharomyces unisporus Y-42 in acidified VJM;

FIG. 5 illustrates transmission electron micrographs of Saccharomyces unisporus Y-42 (A) after different treatments;

FIG. 6 illustrates transmission electron micrographs of Saccharomyces unisporus Y-42 showing the “heaps” of needle” arrangement of chitosan hydrolysates (A) at particular sites on the cell wall (B); and

FIG. 7 illustrates transmission electron micrographs of Saccharomyces bayanus Y-43 after different treatments.

### DETAILED DESCRIPTION OF THE PREFERRED EMBODIMENT

The present invention now will be described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In accordance with the present invention, there is provided hydrolyzed chitosan-lactate that is a molecule showing efficacy for use as a preservative in acidic foods such as fermented vegetables. Antimicrobial activities of chitosan-lactate are greatly modulated by the degree of hydrolysis, the target organisms and the composition of the media.

Another embodiment of the present invention is to provide a method of preserving foods, processed or not, which is broadly effective to prevent foods from deterioration and from denaturation caused by microorganisms, including yeast and/or bacteria, even in the use of small amount of antimicrobial agents. Preferably, the food products targeted for applying the method invention concern fresh fruits or vegetables, processed fruits or processed vegetables.

The present invention relates to a method of preserving foods which comprises adding at least one kind of a natural antimicrobial agent hydrolyzed chitosan-lactate to foods, and storing or processing the food. Hydrolyzed chitosan-lactate can be added to a food product before, during or after processing, such as fermentation, of the food products.

Particularly interesting food products that can be preserved with the method and composition of the present invention are vegetables. The vegetables can be treated with a composition containing hydrolyzed chitosan-lactate as whole, or after processing, or even after having been transformed into pastes or juices.

The present invention will be more readily understood by referring to the following examples, which are given to illustrate the invention rather than to limit its scope.

### EXAMPLE I

### Antimicrobial Action of Hydrolyzed Chitosan Against Spoilage Yeast and Lactic Acid Bacteria of Fermented Vegetables

Materials and Methods

Soluble Chitosan

Hydrolysates and native chitosan-lactate were obtained from ISM Biopolymer Inc. (Sherbrooke, Canada). This 40-g/l chitosan preparation contained 2.5% of food grade DL lactic acid (88%) and had a deacetylation level of 90% (manufacturer's data) (pH 5.5). Native and hydrolyzed chitosan-lactate of different molecular weights were tested in chitosan concentration of 0.5, 1, 2, 5 and 10 g/l. The mean molecular weights of the molecules and degree of polymerization (DP) are presented in Table 1. All samples were sterilized by filtration through 0.22 μm nitrocellulose membranes (Millipore, Milford, Mass., U.S.A.).

Microbial Strains

Microbial strains used in this study included three species of lactic acid bacteria (LAB) used as sauerkraut starter (BLAC 1™, Caldwell BioFermentation Canada Inc, Compton, Canada) and two spoilage yeasts.

LAB were Lactobacillus plantarum NK 312 (Lallemand, St-Simon, France), Pediococcus acidilactici AFERM 772 (Quest, Lachine, Canada) and Leuconostoc mesenteroides BLAC (CRDA, St-Hyacinthe, Canada). Yeast strains were isolated with method known in the art, from spoiled fermented vegetables and identified as Saccharomyces unisporus Y-42 and Saccharonzyces bayanus Y-43. LAB strains were maintained on MRS agar (BDH, Montréal, Canada) at pH 5.6 and yeast strains on YM agar (BDH, Montréal, Canada) at pH 3.5 acidified with 5N HCl.

Antimicrobial Activity Against LAB and Spoilage Yeasts in Agar-based Media

The antimicrobial activity was first examined on Methylene Blue Agar (MBA) as described by Walker et al. (FEMS Microbiol. Lett., 127:213-222). MBA was distributed in aliquots of 15 ml then autoclaved at 121° C. for 15 min and cooled to 45° C. before addition of LAB or yeasts at a final cell number of 1×10⁵ per Petri dish. Target cells were seeded into the molten MBA, mixed gently and then poured in Petri dishes. Five mm diameter punctures were made with a stainless steel punch in the solidified agar in order to obtain wells.

Sterile native and hydrolyzed chitosan solutions (50 μl) at concentrations of 0.5, 1, 2, 5 and 10 g/l were distributed into 5-mm diameter wells. Lactate (2.5%) was used as a negative control. In MBA, test organisms grew as a background lawn and inhibitory activity was evidenced by a clear zone surrounding the well, which could itself be surrounded by blue-stained line (dead) colonies if fungicidal or bactericidal activity was present. Plates were incubated at 30° C. for 72 h and kept at 4° C. for two weeks. Three independent assays were performed in duplicate and diameter of inhibition (clear) zones delimited by the blue line was measured in millimeters.

Antimicrobial Activity Against LAB and Spoilage Yeasts in Liquid Media

Data obtained with agar-based media were compared to those obtained on vegetable juice media (VJM) liquid media by automated spectrophotometer (AS) using a Bioscreen™ apparatus (Labsystems, Helsinki, Finland). The VJM was composed of 61% carrot juice, 12% cabbage juice, 3% onion juice and 24% brine containing 20 g/l sea salt and was prepared according to Gardner et al. (Int. J. Food Microbiol., 66:261-275). The initial pH of the blend was 6.34. To determine the inhibitory potential of chitosan in fermented vegetables, VJM was acidified at pH 3.8 with lactic acid 85%. VJM was supplemented with hydrolyzed chitosan-lactate at 0.5, 1, 2, 5 or 10 g/l and distributed in a 200-well microplate. Wells were inoculated with test strains in triplicate at 0.1% (vov/vol) of 72 h yeast preculture (YM broth, 30° C. for 72 h). For each sample, control conditions without chitosan were made in triplicate and blanks with chitosan without yeasts were subtracted from the mean value obtained for the test wells. Experiments were conducted on three independent assays in triplicate. Incubation of the microplates was carried out at 26° C. for 28 h and the optical density (OD) at 600 nm was measured every 15 min. The Bioscreen ™ unit is designed to shake the microplates and set intervals and, in this study, the microplates were shaken for 20 s prior to and after OD readings.

Electron Microscopy

Samples were examined after four treatments at two pH values (3.8 and 6.0) in order to evaluate the effect of chitosan in function of pH. Saccharomyces unisporus Y-42 and Sc. bayanus Y-43 were pre-incubated at 30° C. for 48 h in YM broth (control). Intermediate hydrolyzed chitosan (DP25) was added at a concentration of 2 g/l and samples were taken after 1 h or 5 h of incubation (first and second treatments). Chitosanase (ISM Biopolymer Inc. Sherbrooke, Canada) was mixed with chitosan-lactate DP25 in the third treatment to confirm the nature of the aggregate and all of them were compared to control without chitosan and chitosanase (control treatment).

After incubation, samples were centrifuged at 4000-x g for 15 min at 4° C. and yeast cells embedded in 4% softened agar (Bacteriological Agar, Difco Laboratories, Detroit, Mich. U.S.A.) (pH 6.0 or 3.8, 45° C.). The remaining gel was cut in small pieces of about 1 mm. Samples were then fixed in 2% glutaraldehyde/cacodylate buffer 0.1 M pH 7.3 for 2.5 h at room temperature, rinsed several times in the same buffer for a total of 1.5 h and postfixed overnight in 2% osmium tetroxide/water at 4° C. Afterwards samples were rinsed three times within 1.5 h, dehydrated in a graded ethanol series (30, 50, 70 and 100%), infiltrated with Spurr resin and polymerized for 24 h at 60° C. Thin sections were obtained, stained with uracyl acetate and lead citrate and observed on a transmission electron microscope at 80 kV (Philips model 420, Eindhoven, The Netherlands).

Results

Antimicrobial Activity of Chitosan-lactate in Agar-based Media

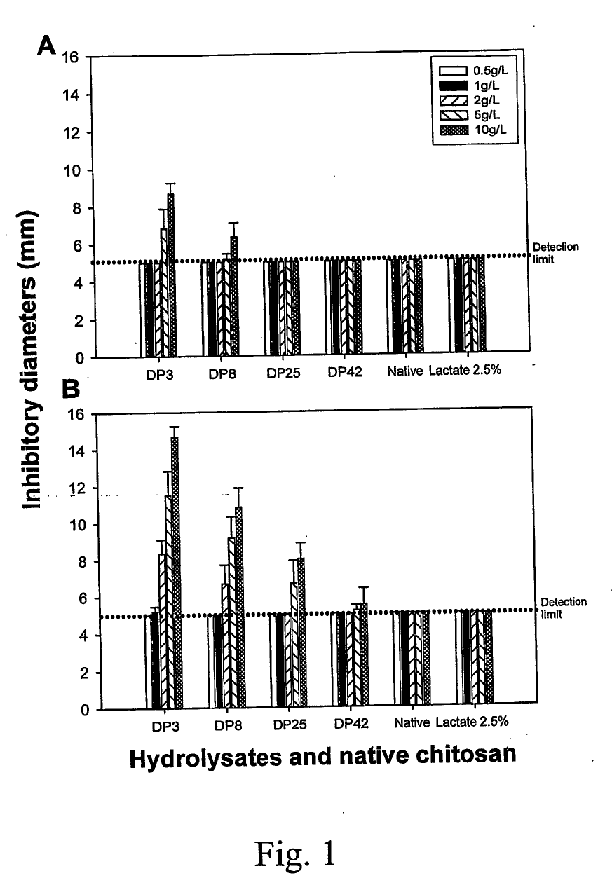

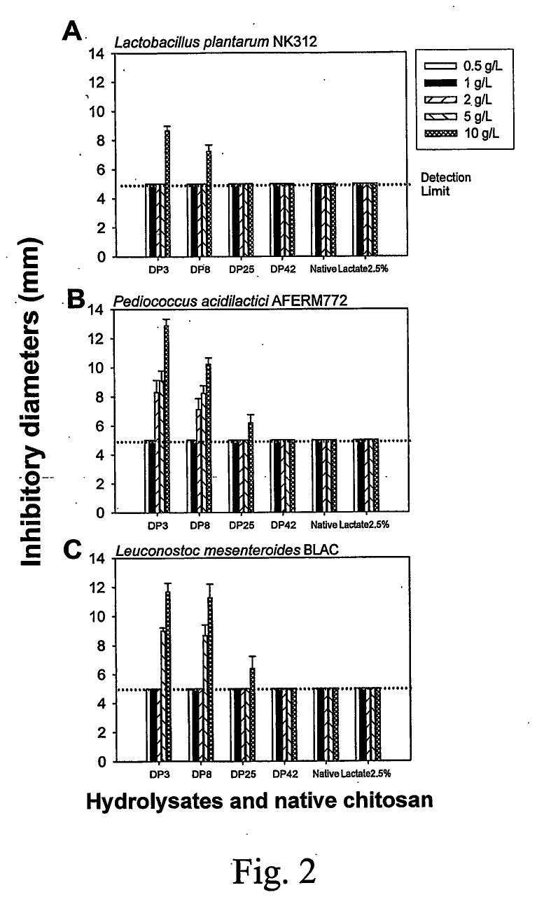

The antimicrobial activities of native and hydrolyzed chitosan-lactate were first assessed on MBA agar. FIGS. 1 and 2 illustrate the level of inhibition for Sc. bayanus Y-43 (FIG. 1-A), Sc. unisporus Y-42 (FIG. 1-B) and for lactic acid bacteria (FIG. 2). The highly degraded chitosan (DP3) showed the greatest inhibitory activity with all microorganisms. Inhibition decreased with increasing molecular weight. Trimers (DP3) were the most potent inhibitor, followed by octamers (DP8). Intermediate molecular weight chitosans (DP25 and DP42) showed little activity and no growth inhibition could be observed with polymers of up to 10 kDa. However, inhibitory activities of the different oligomers were a function of the concentration and the target organism. No growth inhibition was observed with concentrations of 0.5, 1 and 2 g/l for Sc. bayanus Y-43, which needed a minimum of 5 g/l to show inhibition (FIG. 1-A). For Sc. unisporus Y-42, a similar inhibitory pattern was observed even though this strain was more sensitive to chitosan hydrolysates (P<0.002, t-test). Inhibition was also observed on lactic acid bacteria with a minimal inhibitory concentration of 2 g/l and Lactobacillus plantarum was the most resistant of the three strains (FIG. 2). Control conditions with only lactic acid at 2.5% did not shown inhibitory activities.

Based on these results, inhibitory activity of chitosan-lactate was higher with low and intermediate molecular weight hydrolysates and was directly proportional to the concentration added to MBA. Inhibitory activity is lost with hydrolysates between DP8 and DP42 depending on the target organism. These data are consistent with the fact that low molecular weight chitosan was more inhibitory than intermediate and higher molecular weight chitosan in agar systems, although the molecular weight was not specified. Therefore, the fact that lactic acid bacteria were also affected by chitosan implies that chitosan-lactate should not be added at the beginning of vegetable fermentation. However, the MBA agar test was carried out at pH 4.5 and it remains to be determined if a similar inhibition pattern would occur at the higher pH levels encountered at the beginning of vegetable fermentation

Antimicrobial Activity of Chitosan-lactate in VJM Media

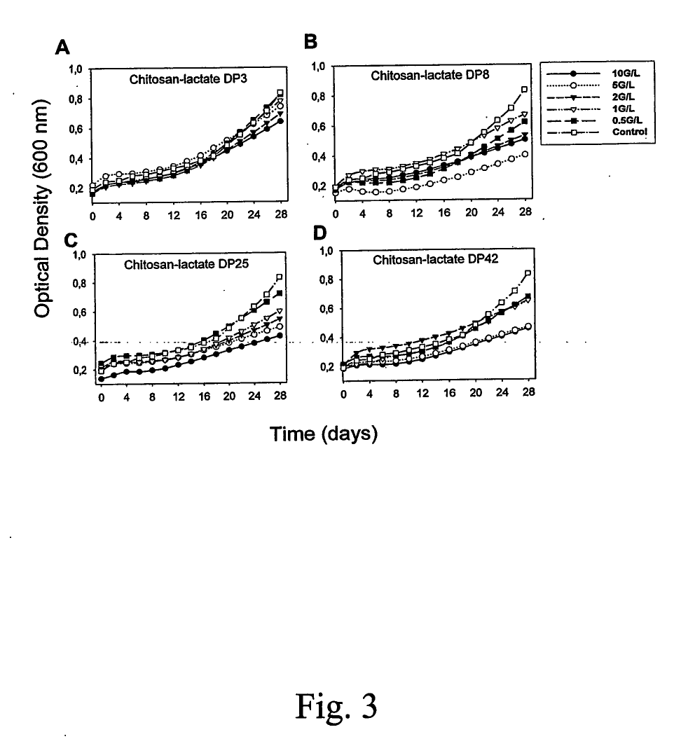

The antimicrobial activities of native and hydrolyzed chitosan-lactate in liquid medium were assessed only on yeast strains, since, at the pH of 3.8 used with VJM, growth of the lactic acid bacteria was critically inhibited and no increase in OD values could be obtained during the recording time (28 h) (data not shown). VJM was used as a complex medium representative of conditions encountered following a lactic fermentation. FIG. 3 shows the growth curves of Sc. bayanus Y-43 in presence of DP3 (A), DP8 (B), DP25 (C) and DP42 (D)) at different concentrations. In contrast to data obtained in agar-based media, all hydrolysates were inhibitory and hydrolysates of intermediate molecular weight became the most potent inhibitors. With Sc. bayanus Y43, all concentrations tested were effective against this yeast but complete growth inhibition was not obtained in this medium with concentrations as high as 10 g/l. Nevertheless, the inhibition was concentration dependent.

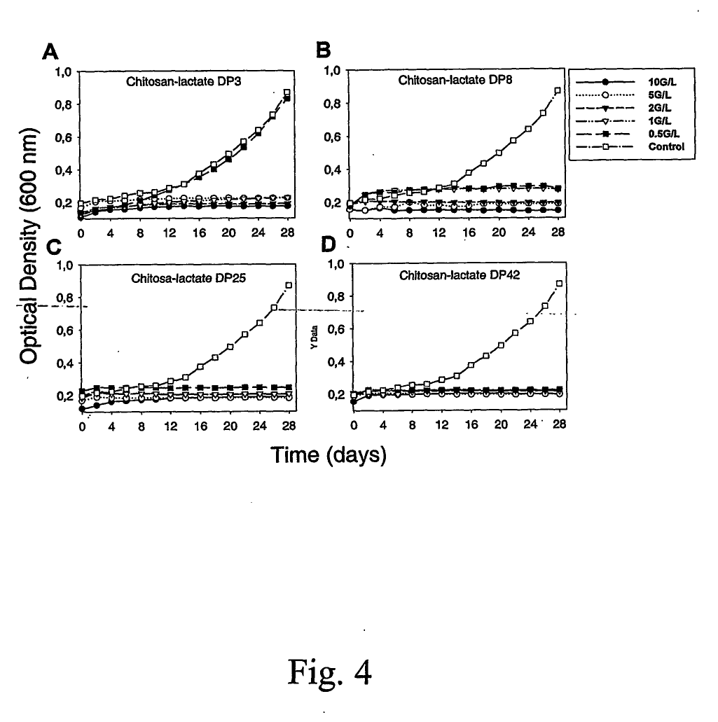

As shown in FIG. 4, Saccharomyces unisporus Y-42 (the most sensitive strain in agar-based media) showed complete growth inhibition at 0.5 g/l except for the trimer (DP3), which did not reduce the growth of this yeast as compared to the control. Interestingly, it has been observed before that Sc. unisporus is more resistant to low pH and acid than Sc. bayanus. This resistance is generally conferred by more effective proton pumping at the cell wall and a more acidic internal cytoplasmic pH. These characteristics are linked with anionic charges on the cell wall and could explain the high sensitivity to the polycationic charge of chitosan-lactate.

The inhibition pattern in liquid medium (VJM) differed from those obtained in solid media (MBA). Hydrolysates of low molecular weight chitosan-lactate were less toxic than hydrolysates of intermediate molecular weight. This confirms that the media composition and the degree of hydrolysis influenced the inhibitory activity of hydrolysates.

The discrepancies observed between liquid and solid media can be explained by the fact that particulate nature of solid media restricted mass transfer of the relatively large, polymeric chitosan molecules, which reduced the chance of contact with a microbial cell in the agar. Another possibility is a dilution factor related to the number of molecules in a static medium. Chitosan stock solutions are prepared with 40 g/l and chitosan is then degraded with chitosanase. For the same initial number of molecules, the most hydrolyzed chitosan showed a higher relative number of molecules than the native one.

Scanning Electronic Microscopy

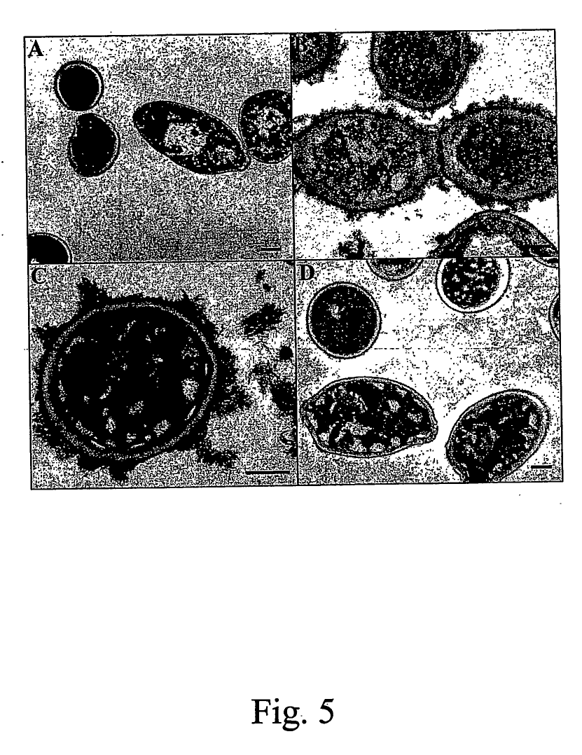

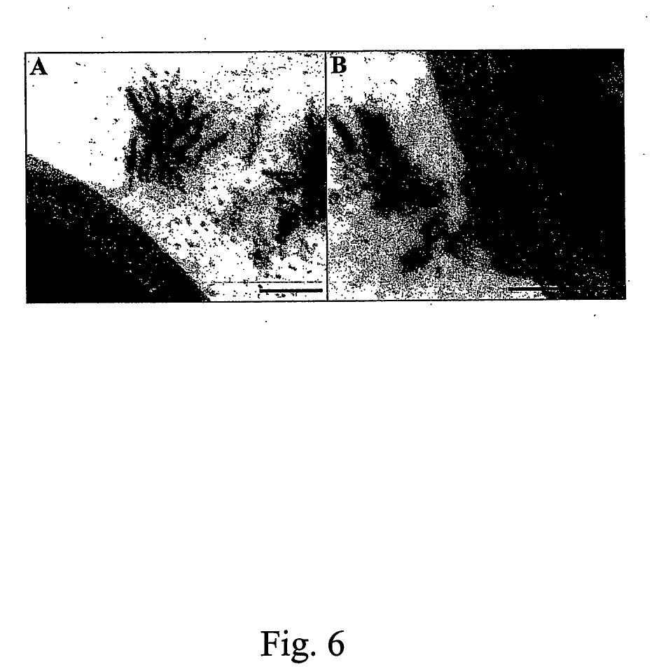

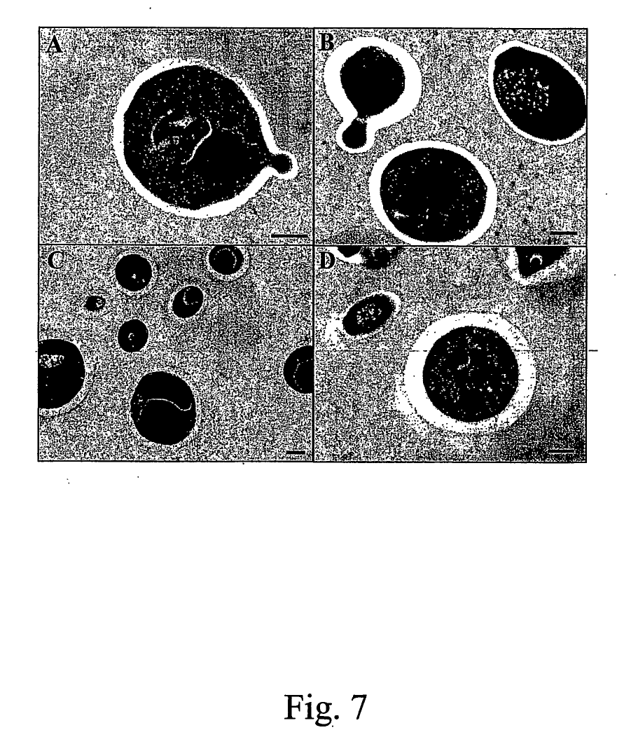

FIGS. 5 and 6 show transmission electron micrographs of Sc. unisporus Y-42. Treatments with chitosan-lactate were examined in YM at pH 3.8 and 6.0 but no differences could be observed between either values, probably because these pH were below the pKa of chitosan (6.34). For this reason, only micrographs of YM at pH 3.8 were presented. For Sc. unisporus Y-42, a thick sheath of refractive substances could be observed around the cell wall after 1 h exposure to chitosan-lactate DP25 (FIG. 5-B) and the thickness of the layer increased with the term of exposure to chitosan-lactate (FIG. 5-C). The adsorption pattern was irregular but often covered the entire cell wall surface. The material had the appearance of a “heap of needles” as shown in FIG. 6-A. The placement of these heaps seemed to be linked at some specific sites of the cell wall (FIG. 6-B). These refractive substances could be hydrolyzed by chitosanase. Furthermore, Sc. bayanus Y-43, the less sensitive strain to chitosan hydrolysates VJM broth (FIG. 3), did not show this coating (FIG. 7).

The results obtained with Sc. unisporus Y-42 reveal an irregular coating and support the phenomenon of “cell suffocation”. This is based on the ability of the reactive amino groups in chitosan to interact with a multitude of anionic groups on the yeast cell surface, thereby forming an impervious layer around the cell, and causing a loss of active transport and a modification of membrane permeability which could become irreversible after a certain point. Therefore, this phenomenon does not exclude the possibility that chitosan causes a more direct disturbance of the membrane function by the leakage of proteinaceous and UV-absorbing materials.

The fact that no coating could be observed on Sc. bayanus Y-43, which also demonstrated a chitosan-lactate sensitivity in both solid and liquid media suggests that the chitosan could have multiple mechanisms of action at the same time that do not necessarily implicate the cell wall or the membrane. It is reported that chitosan could bind a range of heavy metals and trace elements and suggested that the antimicrobial activity of chitosan was principally linked to chelating properties conferred by the polycationic nature of chitosan. This hypothesis could apply to our results but further investigation is needed to verify if this is also the case for Sc. bayanus Y-43. Our results suggest therefore a multiple mechanism of action of chitosan.

TABLE 1
Chemical properties of Chitosan

| | | |
|---|---|---|
| Native chitosan | 1.2 | MDa |
| DP101* | 10 | kDa |
| DP42 | 7 | kDa |
| DP25 | 4 | kDa |
| DP8 | 1.3 | kDa |
| DP3 | 0.5 | kDa |

*Degree of polymerization (DP) and molecular weight were obtained from the manufacturer.
Hydrolysates of chitosan were obtained by enzymatic hydrolysis with chitosanase of Streptomyces sp.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method for preventing degradation or denaturation of processed vegetables comprising treating processed vegetables with a composition comprising hydrolysate chitosan-acid complex, said chitosan-acid complex consisting of an oligomer of chitosan complexed to an acid or an acid group.

2. The method of claim 1, wherein said processed vegetables are fresh fruits or vegetables.

3. The method of claim 1, wherein said chitosan-acid complex has a molecular weight between about 0.5 Kda to 1.2 Mda.

4. The method of claim 1, wherein said vegetables are fermented vegetables or vegetables transformed into paste, juice or liquid solution.

5. The method of claim 1, wherein said hydrolysate chitosan-lactate is added to said processed vegetables before, during or after processing of said vegetables.

6. The method of claim 1, wherein said degradation or denaturation is caused by spoilage or pathogen microorganisms.

7. The method of claim 6, wherein said microorganisms are yeasts or bacteria.

8. The method of claim 7, wherein said bacteria are lactic acid bacteria.

9. The method of claim 7, wherein said yeasts are fermentation yeasts.

10. The method of claim 1, wherein said composition is an aqueous solution.

11. The method of claim 1, wherein said chitosan-acid complex is selected from the group consisting of a chitosan-lactate, a chitosan-acetate, a chitosan-chlorate, a chitosan-proprionate, and chitosan complexed to an acid radical having between 3 to 30 carbon atoms.

12. The method of claim 1, wherein said microorganism is selected from the group consisting ot Pichia, Hansenula, Kluyveromyces, Willipsis, and Kluyveromyces, Leuconostoc, Lactobacillus, Streptococcus, Saccharomyces, Candida, Cryptococcus, Rhodotorula, Shizosaccharomyces, Torulopsis, E. coli, E. coli O157:H7. Salmonella, Staphylococcus, Clostridium, and Bacillus.

13. A composition for preventing degradation or denaturation of processed vegetables comprising hydrolyzed chitosan-acid complex.

14. The composition of claim 13, wherein said chitosan-lactate polymer has a molecular weight between about 0.5 Kda to 1.2 Mda.

15. The composition of claim 13, wherein said microorganism is selected from the group consisting of Pichia, Hansenula, Kluyveromyces, Willipsis, and Kluyveromuyces, Leuconostoc, Lactabacillus, Streptococcus, Saccharomyces, Candida, Cryptococcus, Rhodotorula, Shizosaccharomyces, Torulopsis, E. coli, E. coli O157:H7, Salmonella, Staphylococcus, Clostridium, and Bacillus.

16. The composition of claim 13, wherein said chitosan-acid complex is selected from the group consisting of a chitosan-lactate, a chitosan-acetate, a chitosan-chlorate, a chitosan-proprionate, and chitosan complexed to a radical acid having between 3 to 30 carbon atoms.

17. The composition of claim 13 being a dry or a liquid solution.
